(19) United States
(12) Patent Application Publication
(10) Pub. No.: US 2014/0036495 A1
(43) Pub. Date: Feb. 6, 2014

(54) Laser Luminaire

(71) Applicant: Konstantinos Gavriil, Athens (GR)

(72) Inventor: Konstantinos Gavriil, Athens (GR)

(21) Appl. No.: 13/261,676

(22) PCT Filed: Dec. 15, 2011
(86) PCT No.: PCT/GR11/00056

§ 371 Date: Oct. 18, 2013

(30) Foreign Application Priority Data
Dec. 16, 2010 (GR) 20100100725

(51) Int. Cl. F21K 99/00

(52) U.S. Cl. CPC F21K 9/50
USPC 362/235

(57) ABSTRACT

The laser luminaire consisting of one or more laser light sources (2) and one or more light diffusion elements (5, 8) and is characterized by the fact that the light output comes from the diffusion that happens on the light diffusion elements when illuminated by laser light from said laser light sources, which diffuse laser light evenly from entire the surface and towards all directions. The light diffusion elements are distributed in space forming concrete or abstract shapes thus forming an aesthetic creation and they are made of transparent materials suitable painted or translucent material, in any shape or size. The advantages of this invention is that the observer perceives that it is the aesthetic creation that produces the light and realizes that the light diffusion elements are self-luminous bodies (where in reality they are not) and is impressed by the nature of the light which is coherent. Also the aesthetic creation is free from any unsightly electrical installation.

The invention refers to laser luminaire that is intended mainly for interior use where the produced light occurs from the diffusion of laser light.

As it is well known, the production of the light that is emitted by conventional light fittings occurs through the use of common bulbs such as incandescent, fluorescent, new economic light bulbs, LED diodes; etc. There is also a wide use of lighting fittings which are decorated with objects like: glass objects, crystal objects, fabric or other materials that both make an aesthetic creation (eg chandeliers) and also scatter the light either in whole or in part in order to prevent the light rays to reach directly from the point source (lamp) to the human eye. Furthermore said objects although they scatter the light from their surface, an observer easily can perceive that are not self-illuminated objects as often the existence of light sources is obvious. Also the aesthetic result often is being undermined because the electrical installations such as lamps, lamps bases, supports and also necessary wirings are visible.

On the other hand, and regarding with devices that are using laser light sources for illumination, also it is well known that these devices often contain diffusers that are capable to diffuse the laser light beams. But according to this invention these diffusers have one or more limitations such:

They are capable to diffuse the laser light towards only one direction in a form of a diverging beam.
They cannot be observed from any direction, because on some directions they can reflect strong laser beams harmful to human eye, so only a part of them can be exposed to an observer (eg glass plates having their output surface irregular).
They should have specific shapes.
They do not defuse light evenly from the entire surface, or they diffuse light only from a limited area of their surface.
There is the need to contain a laser source inside of them.
Note: in the following text anywhere mention the word “light” is understood that means “laser light”.

According to this invention the laser luminaire provides an alternative way of discreet lighting that can be used mainly indoor and also can be an ornamental element. It consists of one or more laser light sources and of one or more light diffusion elements. Light diffusion elements are three-dimensional objects that are capable to diffuse most of the laser light energy that they receive from said laser sources, rather than reflect or absorb it, and also, the diffusion happens evenly from their entire surface and towards all directions. Each one of the light diffusion elements is illuminated by one or more laser light sources. Hence the light that is produced from the laser luminaire comes from the diffusion of the laser light that take place on the light diffusion elements when they are illuminated by said laser light sources.

The light diffusion elements (hereinafter referred to as: LDE) are arrangement in space. Usually they are hung but can be also supported on a base or fitted by any other known way and they can be observed from any direction. When the LDEs are more than one then as a total they can form abstract or specific shapes therefore resulting in an aesthetic creation (even when there is only one LDE this can be an aesthetic creation itself). So as the laser light is diffused from the LDEs that form the aesthetic creation, the observer perceives that the light comes from the aesthetic creation itself, perceiving the LDEs and therefore the aesthetic creation as self-luminous bodies, when in reality they are not. Also the aesthetic creation that produces the light is free from any electrical installation because the LDEs can be illuminated from distance keeping the necessary electrical installation (like laser modules, adapters, wiring etc.) far enough.

For each LDE corresponds at least one source of laser light that illuminates it. This means that it is possible to have more than one laser light source to illuminating the same LDE from the same or a different direction using the same or different wavelength emission laser light.

The laser light derives from any known source of laser light (usually laser diodes modules) and are usually placed in the perimeter of the aesthetic creation that it illuminates. The distance between the LDE surface and the laser light source that illuminates it can be from zero to several meters.

According to this invention the light diffusion elements are bodies that have the ability to diffuse the laser light that they receive. Also the LDEs should be efficient. By the term “efficient” we mean that the laser light energy that they receive from the laser sources should be diffused uniformly from their entire surface and towards all directions, with the minimum light absorption. Moreover, they should not reflect strong individual light rays in any direction that is harmful to the human eye. To meet these requirements, the light diffusion elements should be constructed by suitable materials. We distinguish two main categories of materials:

In the first category light diffusion elements are made of transparent materials like crystal, glass, acrylic glass, etc. Also the whole surface of them should be coated with a layer of paint that makes them translucent. As the LDEs are three-dimensional objects the said translucent coating takes the form of the same three-dimensional shape in space, which shows no discontinuities. Thus, as it has been proven in practice only a small part of the laser light energy that illuminates the LDE is reflected at the point of prolapse on the surface of the LDE. The bulk of that energy is diffused uniformly towards all directions from the entire painted surface of the LDE. However we must abide by the following two rules regarding to the thickness and the color of the paint:

The first rule is related to the thickness of the paint applied on the LDE. This is such that, as mentioned above, after its application on the LDE its surface becomes partially permeable (translucent) to the laser light that illuminates it. To determine the appropriate thickness of paint necessary, we have to follow this procedure: we apply to the entire surface of the LDE a very thin layer of paint (preferably inform of spray) and then illuminate the LDE with the desirable power of laser light. If the LDE is reflecting strong individual rays (behaves like a prism), then we repeat the same process applying new layers of paint until it stops reflecting strong individual rays and thus diffusing light evenly from its entire surface. Then we obtain the correct thickness of coating. Extra layers of paint are not desirable because this makes the surface of LDE less permeable to the laser light and thus making it less bright.

The second rule has to do with the color of the paint. As is known, mono-chromatic is one of the properties of laser light, meaning that the light energy is concentrated within a very tight spectral (wavelength) band (for example 650 nm wavelength for a red light laser). Consequently the light diffusion elements are painted with a color that has high reflectivity to the wavelength of the laser light that illuminates them. Otherwise, the LDE will absorb the light and remain dark. So when a LDE is illuminated with a laser light at 650 nm wavelength (red), then it should be painted with a color that has high reflectivity at this wavelength (650 nm), for instance red or white.

In the following examples (1, 2,3) there has been use of LDEs made with transparent materials and the entire surface of them is painted with fluorescent varnish of nitrocellulose in a spray form. This invention does not exclude the use of other types of paints and other coating methods which give the LDEs the above properties.

In the second category, the light diffusion elements are made of translucent materials. Here the diffusion of light is created by the entire mass of the light diffusion element and not just from its surface as in the first category. Examples of such materials are translucent plastics, some natural crystals as the white translucent quartz, etc. These materials can be used as such without painting their surface. In that category, the translucent material of the LDE must have high reflectivity at the wavelength of the laser light that illuminates the LDE. So we can-illuminate a LDE made of red translucent plastic with red laser light (wavelength for example 650 nm), while the white translucent quartz can be illuminated by any laser wavelength, as it is known that white color shows high reflectance in all wavelengths of the visible spectrum.

According to this invention, a light diffusion element can have any shape. It can be amorphous (eg piece of quartz), geometric (eg glass sphere) or it can be an aesthetic creation (eg crystal statuette). There is also no limit to the size it can have. As its volume grows, we can illuminate it with proportionally greater laser light power. Also it can have a compact structure or not. In order to make the diffusion of light more homogenous, the laser rays should aim at the center of its mass but this is not always necessary. Finally when it is particularly oblong then it is preferable that the laser beam that aims at it is parallel to its longitudinal axis.

The output power of each laser source that illuminates a LDE is usually between 3 mw and 50 mw without excluding the use of smaller or more powerful sources. A typical example of a LDE that diffuses light of adequate intensity would be a crystal ball with a diameter of 5 cm, painted exteriorly with red fluorescent varnish of nitrocellulose that is illuminated by laser source of 20 mw power at wavelength of 635 nm (red).

Although the aesthetic creation that produces the light is free from any electrical installation because the illumination of the LDEs can be done from distance, the laser luminaire, according to this invention, does not exclude the integration of any conventional light source.

Finally the laser luminaire, according to the present invention, provides an alternative way of discreet lighting that can be used mainly indoor and also can be an ornamental element. The observer perceives that it is the aesthetic creation that produces the light and realizes that the light diffusion elements are self-luminous bodies (where in reality they are not) and also is impressed by the nature of the light which is coherent.

The following examples are in accordance with some embodiments of the invention and all figures are not necessarily to scale.

### EXAMPLE 1

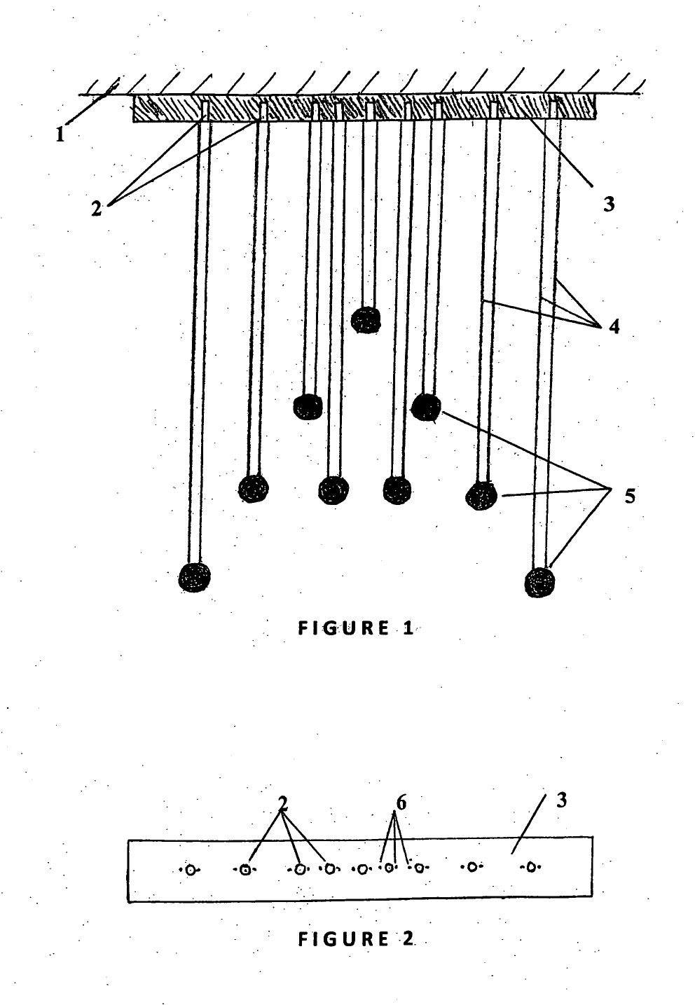

FIG. 1 depicts a ceiling laser luminaire. It consists of nine light diffusion elements (5) which form on a vertical plane the letter “A”. Each LDE consists of a crystal ball with a diameter of 4 cm which has at the top a hole to use for hanging. The entire surface of each crystal ball has been applied with red fluorescent varnish of nitrocellulose in spray form. Each crystal ball is supported with a thin wire rope (4) which comes from a metal base (3) (which is mounted on the ceiling (1)) then passes through the crystals ball hole and returns to the metal base. On this metal base and between the two points of wire rope support (6) (see FIG. 2) there are cylindrical nests. Inside each nest there is a cylindrical diode laser module (2) which emits red laser rays with output power of 20 mw and at a wavelength of 635 nm (red). So above all the LDEs (nine LDEs) are located the corresponding (also nine) laser light sources (2) which emit laser rays aiming at their surface. We also realize that the purpose of the metal base (3) apart from its use for hanging the LDEs is also used to contain the laser sources (in this case the red laser diodes modules (2)) and to direct them to target the laser light on the LDEs surface. FIG. 2 shows how the metal base (3) looks from below where we can see the round nests that contain the laser sources (2) and the mounting of wire ropes (6) which straddle the round nests.

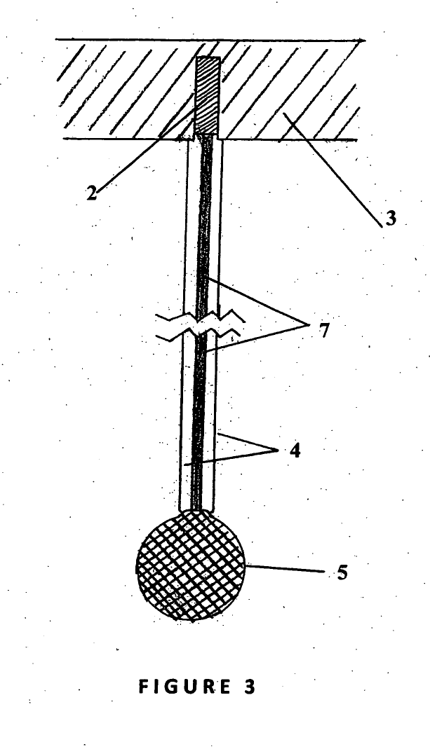

The detail in FIG. 3 shows the metal base (3), the round nest containing the laser sources (2), the light diffusion element (5), the thin wire rope (4) and the laser beam (7) that is targeting the LDE. The observer perceives the LDEs and consequently the aesthetic creation with the shape “A”, as a self-luminous body that diffuses an intense red light towards all directions.

### EXAMPLE 2

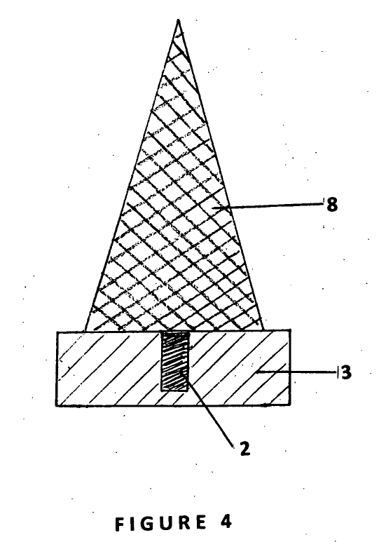

FIG. 4 depicts a table laser luminaire with a single light diffusion element. It consists of a transparent crystal pyramid (8) with a height of 20 cm that is supported on a metal base (3). On the entire surface of the crystal pyramid there has been applied green fluorescent varnish of nitrocellulose in spray form. Inside the metal base(3) there is a cylindrical nest containing a laser light source (2) (in this case a laser diode module) emitting laser rays with power of 30 mw and wavelength of 532 nm (green) which comes in contact with the surface of the LDE (crystal pyramid) that it illuminates. The observer perceives that the light comes from the entire surface of the pyramid as this diffuses a bright green light towards all directions.

### EXAMPLE 3

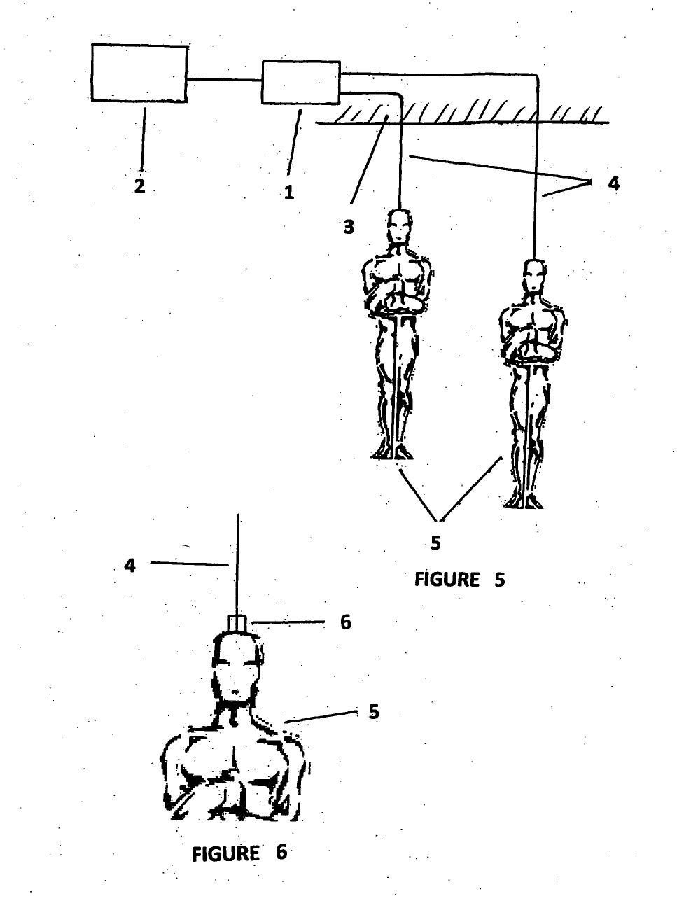

FIG. 5 depicts a hanging laser luminaire, consisting of two light diffusion elements (5) having the shape of a statuette. They are made of transparent acrylic glass and their entire surface is coated with red fluorescent varnish of nitrocellulose in spray form. Inside a base (3) (which can be mounted on ceiling) there is one laser source (2) (eg a red DPSS laser) which delivers laser light through an optic fiber to a splitter (1) (eg a PLC splitter). The splitter (1) delivers this laser light through two multimode optical fibers (4) and illuminates each LDE on its upper surface. As we can see on the detail of FIG. 6, the end of each optical fiber (4) is in touch (without a collimator) with the LDE surface. This can be made with the help of a plastic device (6) that is used to attach the LDE (5) with the optical fiber (4). We also realize that the purpose of the optical fibers is to deliver laser light that illuminate the LDEs and also to hang them from the base (3) (instead of the wire rope being used in example 1). Red laser light is diffusing from the entire surface of the two statuettes and towards all directions.

1. The laser luminaire is composed of one or more known . laser light sources (2) and by one or more light diffusion elements (5,8) and is characterized by the fact that said light diffusion elements are three-dimensional objects with no design restriction, with or without a compact structure that when illuminated from any distance by laser light that derives from said laser light sources they diffuse this light in the environment evenly from their entire surface and towards all directions (conspicuous) without reflecting laser rays that are dangerous to the human eye and said light diffusion elements are distributed in space and may as a whole (when more than one) form concrete or abstract shapes thus resulting in an aesthetic creation which either as separate units (light diffusion elements) or in total (aesthetic creation), the observer perceives them as self-luminous whilst the observation can be safely made from any direction.

2. The laser luminaire, according to claim 1, is characterized by the fact that the laser light, that illuminates the light diffusion elements, in order to diffused evenly towards all directions and from the entire surface of the light diffusion elements and furthermore in order to avoid the reflection from them, of strong laser light rays that are harmful to the human eye, the light diffusion elements are made of transparent materials whose entire surface is coated with paint so as to make them partially permeable (translucent) by the laser light that illuminates them therefore allowing the light to diffuse from their entire painted surface and also in order for said light diffusion elements to diffuse in the environment the largest part of the lighting energy that they receive from the laser light sources, the color of said painting must have high light reflectivity at the wavelength of light that characterizes the laser light that illuminates them.

3. The laser luminaire, according to claim 1, is characterized by the fact that the laser light, that illuminates the light diffusion elements, in order to diffused evenly towards all directions and from the entire surface of the light diffusion elements and furthermore in order to avoid the reflection from them, of strong laser light rays that are harmful to the human eye, the light diffusion elements are made of translucent materials and also in order for said light diffusion elements to diffuse in the environment the largest part of the lighting energy that they receive from the laser light sources that illuminate them, said translucent materials should have high reflectivity of light at the wavelength of light that characterizes the laser light that illuminates them.

4. The laser luminaire, according to all the above claims, is characterized by the fact that the distance between each source of laser light and the surface of the light diffusion element that illuminates it, can be from zero to several meters.

5. The laser luminaire, according to all the above claims, is characterized by the fact that each light diffusion element may be illuminated by one or more laser light sources.

6. The laser luminaire, according to all the above claims, is characterized by the fact that the illumination of each light diffusion element, when more than one sources of laser light illuminates it, can be achieved from the same or different directions using the same or different wavelengths of light.
